(19) United States
(12) Patent Application Publication
(10) Pub. No.: US 2021/0234448 A1
(43) Pub. Date: Jul. 29, 2021

(54) TWO DEGREE-OF-FREEDOM HIGH TILT TORQUE MOTOR, SYSTEM, AND AERIAL VEHICLE INCORPORATING THE SAME

(71) Applicant: HONEYWELL INTERNATIONAL INC., Charlotte, NC (US)

(72) Inventors: Sivanagamalleswara Bavisetti, Bangalore (IN); Deepak Mahajan, Bangalore (IN); Renukaprasad N, Bangalore (IN); Subhashree Rajagopal, Bangalore (IN)

(73) Assignee: HONEYWELL INTERNATIONAL INC., Charlotte, NC (US)

(21) Appl. No.: 17/092,557

(22) Filed: Nov. 9, 2020

(30) Foreign Application Priority Data
Jan. 27, 2020 (IN) 202011003534

(51) Int. Cl. H02K 26/00; H02K 1/27; H02K 1/14; B64C 39/02

(52) U.S. Cl. CPC H02K 26/00; H02K 1/27; H02K 1/14; H02K 2201/18; B64C 2201/042; B64C 2201/027; B64C 39/024

(57) ABSTRACT

A two degree-of-freedom motor includes a stator, a plurality of stator windings, a rotor, a shaft, a limited angle torque motor, and a spring. The stator has a main body and a plurality of stator poles. The stator windings are wound around the stator poles. The rotor is spaced apart from the stator and includes a plurality of magnets and is configured to rotate about a first rotational axis. The shaft is coupled to the rotor and is rotatable therewith and and has a shaft first end and a shaft second end. The limited angle torque motor is coupled to the shaft first end, and is operable to supply a torque that causes the shaft, the rotor, and the stator to rotate about a second rotational axis that is perpendicular to the first rotational axis. The spring is fixedly mounted and is coupled to the limited angle torque motor.

### CROSS REFERENCE TO RELATED APPLICATION

The present application claims benefit of prior filed Indian Provisional Patent Application No. 202011003534, filed Jan. 27, 2020, which is hereby incorporated by reference herein in its entirety.

### TECHNICAL FIELD

The present invention generally relates to multi degree-of-freedom motors, and more particularly relates to two degree-of-freedom high tilt torque motors, systems, and aerial vehicles that incorporate the same.

### BACKGROUND

Recent developments in the field of UAV (Unmanned Aerial Vehicles), drones for unmanned air transport, robotics, office automation, and intelligent flexible manufacturing and assembly systems have necessitated the development of precision actuation systems with multiple degrees of freedom (DOF). Conventionally, applications that rely on multiple (DOF) motion have typically done so by using a separate motor/actuator for each axis, which results in complicated transmission systems and relatively heavy structures.

With the advent of spherical motors, there have been multiple attempts to replace the complicated multi-DOF assembly with a single spherical motor assembly. A typical spherical motor consists of a central sphere on which coils are wound, which may be orthogonally placed from each other. The sphere is surrounded by multi-pole magnets in the form of an open cylinder. The coil assembly is held axially and maintained in a vertical position via, for example, a metal post. The outer cylinder is held by a yoke/frame via a bearing, which allows the cylinder to be rotatable about its axis. The yoke is further connected to the metal post of the coil assembly via a second bearing, which allows the yoke, along with the cylinder, to be rotatable about one or two additional axes.

Unfortunately, current attempts to apply the spherical motor to the certain applications, such as UAVs and robotics, have led to several spherical motor design concepts. Unfortunately, many of these design concepts suffer certain drawbacks. For example, many exhibit relatively limited torque and precise positioning, especially in the tilt axis. This is due, at least in part, to a relatively large air gap between the magnets and inner spherical stator (due in part to the windings) and a relatively heavy spherical stator. The current concepts also exhibit relatively high winding temperatures, relatively complicated and time-consuming winding patterns,

Hence, there is a need for a multi-degree-of-freedom electromagnetic machine that at least exhibits improved generated torque and position precision—especially in the tilt axis, improved thermal handling capabilities, improved speed range, and simpler coil winding configurations as compared to presently known spherical motors. The present invention addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a two degree-of-freedom motor includes a stator, a plurality of stator windings, a rotor, a shaft, a limited angle torque motor, and a spring. The stator has a main body and a plurality of stator poles extending radially outwardly from the main body. The stator windings are wound around the stator poles and are operable, upon being energized, to generate a magnetic field. The rotor is spaced apart from the stator and includes a plurality of magnets and is configured to rotate about a first rotational axis. The shaft is coupled to the rotor and is rotatable therewith about the first rotational axis. The shaft extends through the stator and has a shaft first end and a shaft second end. The limited angle torque motor is coupled to the shaft first end, and is operable, upon being energized, to supply a torque to the shaft that causes the shaft, the rotor, and the stator to rotate about a second rotational axis that is perpendicular to the first rotational axis. The spring is fixedly mounted and is coupled to the limited angle torque motor.

In another embodiment, a two degree-of-freedom motor system includes a stator, a plurality of stator windings, a rotor, a shaft, a limited angle torque motor, a spring, and a control. The stator has a main body and a plurality of stator poles extending radially outwardly from the main body. The stator windings are wound around the stator poles and are operable, upon being energized, to generate a magnetic field. The rotor is spaced apart from the stator, and includes a plurality of magnets and is configured to rotate about a first rotational axis. The shaft is coupled to the rotor and is rotatable therewith about the first rotational axis. The shaft extends through the stator and has a shaft first end and a shaft second end. The limited angle torque motor is coupled to the shaft first end, and is operable, upon being energized, to supply a torque to the shaft that causes the shaft, the rotor, and the stator to rotate about a second rotational axis that is perpendicular to the first rotational axis. The spring is fixedly mounted and is coupled to the limited angle torque motor. The control is in operable communication with the stator windings and the limited angle torque motor, and is configured to controllably supply current to the stator windings and the limited angle torque motor.

In yet another embodiment, an unmanned aerial vehicle (UAV) includes an airframe, a plurality of propellers, and a plurality of two degree-of-freedom motors. The propellers are rotatable relative to the airframe and the two degree-of-freedom motors are mounted on the airframe. Each two degree-of-freedom motor is coupled to a different one of the propellers, and each includes a stator, a plurality of stator windings, a rotor, a shaft, a limited angle torque motor, and a spring. The stator has a main body and a plurality of stator poles extending radially outwardly from the main body. The stator windings are wound around the stator poles and are operable, upon being energized, to generate a magnetic field. The rotor is spaced apart from the stator, and includes a plurality of magnets and is configured to rotate about a first rotational axis. The shaft is coupled to the rotor and is rotatable therewith about the first rotational axis. The shaft extends through the stator and has a shaft first end and a shaft second end. The shaft second end is coupled to one of the propellers. The limited angle torque motor is coupled to the shaft first end, and is operable, upon being energized, to supply a torque to the shaft that causes the shaft, the rotor, and the stator to rotate about a second rotational axis that is perpendicular to the first rotational axis. The spring is fixedly mounted and is coupled to the limited angle torque motor.

Furthermore, other desirable features and characteristics of the two degree-of-freedom motor, system, and aerial vehicle will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a simplified cross-sectional view of one embodiment of a two degree-of-freedom motor;

FIGS. 2A and 2B depict a cross-sectional view of a portion of the two degree-of-freedom motor depicted in FIG. 1;

FIG. 3 depicts a cross-sectional view of one embodiment of a limited angle torque motor that may be used in the two degree-of-freedom motor depicted in FIG. 1;

FIG. 4 depicts a plan view of a portion of the limited angle torque motor depicted in FIG. 3;

FIG. 5 depicts a functional block diagram of a multi-degree-of-freedom control system;

FIGS. 6 and 7 graphically depict torque vs. current and torque vs. tilt angle, respectively, for the limited angle torque motor depicted in FIG. 3;

FIG. 8-11 depict various embodiments of an armature and pole pieces that may be used to implement the limited angle torque motor depicted in FIG. 3;

FIG. 12 graphically depicts the torque vs. current characteristics for the limited angle torque motor when implemented with each of the different armature and pole pieces of FIGS. 8-11;

FIGS. 13 and 14 depict two additional embodiments of an armature and pole pieces that may be used to implement the limited angle torque motor depicted in FIG. 3; and

FIG. 15 depicts one embodiment of an unmanned aerial vehicle that may include the two degree-of-freedom motor depicted in FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

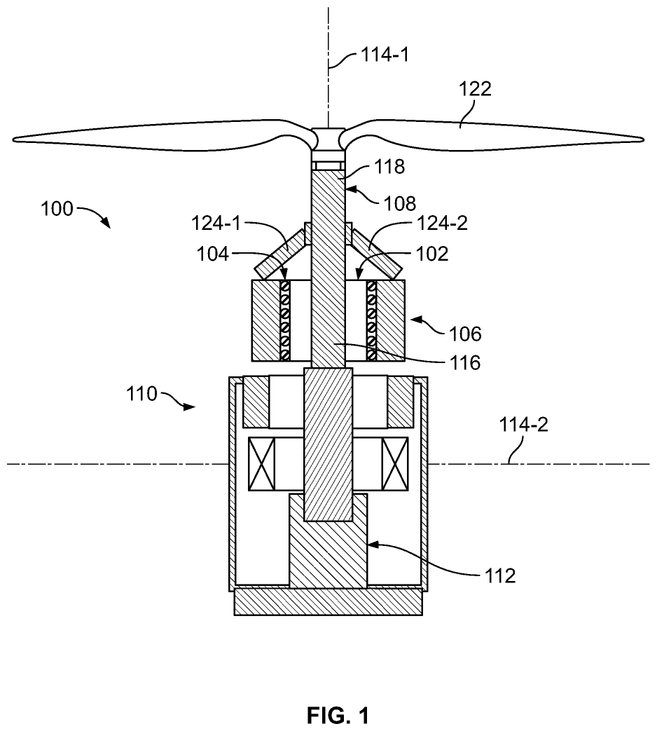

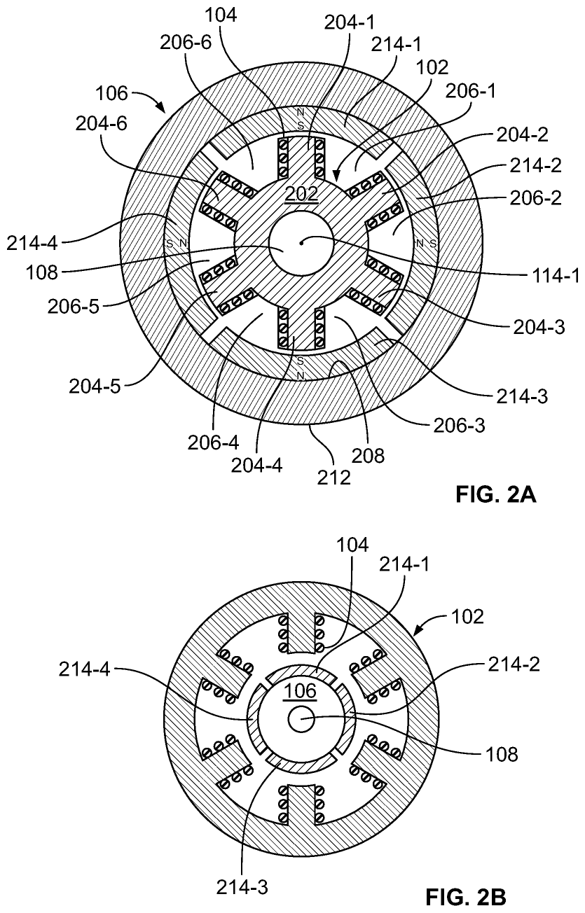

Referring to FIG. 1, a simplified cross-sectional view of one embodiment of a two degree-of-freedom motor 100 is depicted and includes a stator 102, a plurality of stator windings 104, a rotor 106, a shaft 108, a limited angle torque motor 110, and a spring 112. The stator 102, as shown more clearly in FIG. 2A, includes a main body 202 and plurality of stator poles 204. The stator poles 204 extend radially outwardly from the main body 202 and define a plurality of stator slots 206. In the depicted embodiment the stator 102 is implemented with six stator poles 204 (204-1, 204-2, 204-3, . . . 204-6), and thus six stator slots 206 (206-1, 206-2, 206-3, . . . 206-6). It will be appreciated, however, that the stator could be implemented with more or less than this number of stator poles 204 and stator slots 206. The stator 102 may be formed of any one of numerous magnetic or non-magnetic materials. Preferably, however, it is formed of a magnetic material, and most preferably laminated magnetic material. Some non-limiting examples of suitable magnetic materials include any one of numerous known silicon steels, such as M19, M27, M36, and M43, or any one of numerous known alloys such as Hiperco® 50 Alloy, and ASTM A848, or any one of numerous magnetic iron materials such as DT4C, just to name a few.

Regardless of the number of stator poles 204 and stator slots 206, the stator windings 104 are wound around the stator poles 204 and extend through the stator slots 206. The stator windings 104 may be wound in either concentrated or distributed fashion within these slots 206. In the depicted embodiment, it is noted that the stator windings 104 are implemented as 3-phase windings. In other embodiments, however, the distributed stator windings 104 may be implemented with N-number of phases, where N is an integer greater than or less than three. Regardless of the number phases, the stator windings 104 are operable, upon being energized, to generate a magnetic field.

With continued reference to FIG. 2A, it is seen that the rotor 106 is spaced apart from, and surrounds a least a portion of, the stator 102. The rotor 106 is operable to rotate, relative to the stator 102, about a first rotational axis 114-1 (see FIG. 1), and includes an inner surface 208, an outer surface 212, and a plurality of magnets 214. The rotor 106 may be formed of any one of numerous magnetic or non-magnetic materials. Preferably, however, it is formed of a magnetic material, and most preferably laminated magnetic material. Some non-limiting examples of suitable magnetic materials include any one of numerous known silicon steels, such as M19, M27, M36, and M43, or any one of numerous known alloys such as Hiperco® 50 Alloy, and ASTM A848, or any one of numerous magnetic iron materials such as DT4C, just to name a few. In the embodiment depicted in FIG. 2A, the magnets 214 are coupled to the inner surface 208 of the rotor 106 and extend radially inwardly toward the stator poles 204. In other embodiments, such as the one depicted in FIG. 2B, the stator 102 at least partially surrounds the rotor 106, and the magnets 214 are coupled to the outer surface 212 of the rotor 106 and extend radially outwardly toward the stator poles 204.

It is noted that the depicted embodiments (FIGS. 2A and 2B) are both implemented with four magnets 214 (214-1, 214-2, 214-3, 214-4). It will be appreciated, however, that this is merely exemplary and that there could be more or less than this number of magnets 214. Regardless of the specific number, each magnet 214 is preferably arranged such that the polarity of half of the magnets 214 relative to the stator 102 is opposite to the polarity of the other half of the magnets 214. To maximize efficiency, the magnets 214 are preferably implemented using high-grade permanent magnets. The magnets 214 could also be implemented using a Halbach array.

Returning now to FIG. 1, it is seen that the shaft 108 extends through the stator 102 and has a shaft first end 116 and a shaft second end 118. The shaft first end 116 is coupled to the limited angle torque motor 110, and the shaft second end 118 is coupled to a load 122. The load 122 may be implemented using any one of numerous types of loads, but in the depicted embodiment the load 122 is a propeller. The shaft 108 is also coupled to the rotor 106. In the depicted embodiment, the shaft 108 is coupled to the rotor 106 via two bearing structures 124-1, 124-2 that are connected to the rotor 106 and disposed 180-degrees apart from each other. Because the shaft 108 is coupled to the rotor 106, the shaft 108 is rotatable with the rotor 106 about the first rotational axis 114-1. The shaft 108 is preferably formed of a non-magnetic material such as, for example, any one of numerous 300 series stainless steel alloys, Inconel 718, 15-5 PH stainless steel, or PEEK (polyetheretherketone), just to name a few.

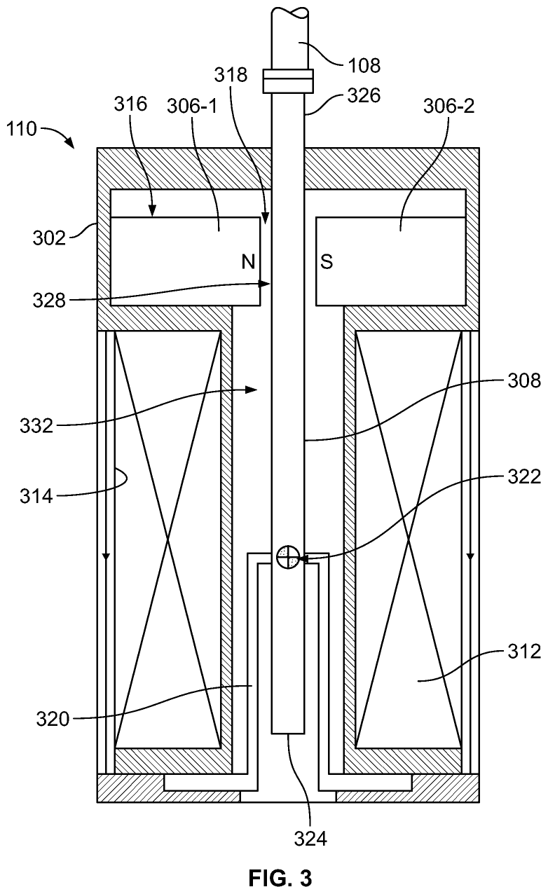

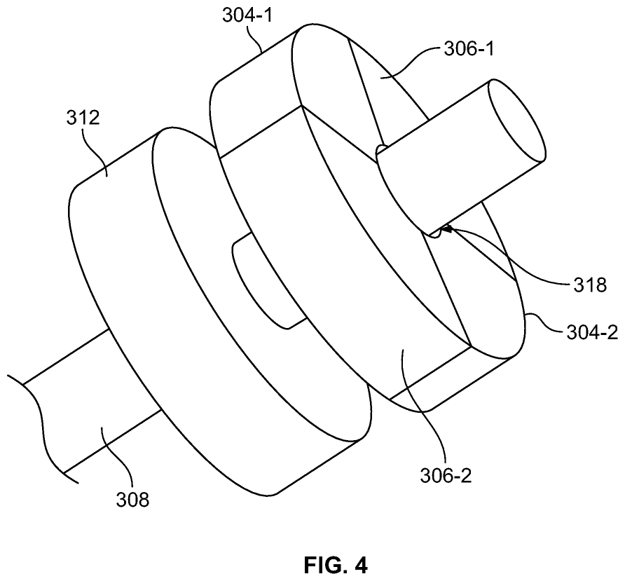

The limited angle torque motor 110, as was noted above, is coupled to the shaft first end 116. The limited angle torque motor 100 is configured to selectively supply a torque to the shaft 108. More specifically, the limited angle torque motor 110 is operable, upon being electrically energized, to supply a torque to the shaft 108 that, because the shaft 108 is coupled to the rotor 106, causes the shaft 108 and the rotor 106 to rotate. In particular, it causes the shaft 108 and rotor 106 to rotate about a second rotational axis 114-2 that is perpendicular to the first rotational axis 114-1. One embodiment of the limited angle torque motor 110 is depicted more clearly in FIGS. 3 and 4, and with reference thereto will now be described.

The depicted limited angle torque motor 110 includes a housing 302, a plurality of pole pieces 304 (shown most clearly in FIG. 4), a plurality of permanent magnets 306, an armature 308, and an actuation coil 312. The housing 302 has a housing inner surface 314 that defines a housing cavity 316. The pole pieces 304 and the permanent magnets 306 are coupled to the housing inner surface 314 and extend into the housing cavity 316. As FIG. 4 depicts most clearly, each permanent magnet 306 is disposed between two of the pole pieces 304. In the depicted embodiment, there are two pole pieces 304 (304-1, 304-2) and two permanent magnets 306 (306-1, 306-1). In other embodiments, however, there could be more than this number of pole pieces 304 and permanent magnets 306. No matter the specific number, the pole pieces 304 and permanent magnets 306 define an armature opening 318, through which a portion of the armature 308 extends.

The armature 308 is rotationally mounted within the housing cavity 316 to rotate, at a pivot 322, about the second rotational axis 114-2. The armature 308 includes an armature first end 324 and an armature second end 326. The armature first end 324 is disposed within the housing cavity 316 and is coupled to a spring 320. The armature second end 326 extends from the housing cavity 316 and is coupled to the shaft 108. As noted above, a first portion 328 of the armature 308 extends into and through the armature opening 318 and is thus at least partially surrounded by the pole pieces 304 and permanent magnets 306. A second portion of the armature 332 is surrounded by the actuation coil 308, which is disposed adjacent to the plurality of poles 304 and to the plurality of permanent magnets 306 and is adapted to receive a control current.

The spring 320 is fixedly mounted and is coupled to the limited angle torque motor 110. In the depicted embodiment, the spring 320 is fixedly mounted to the housing 302 within the housing cavity 316 and is coupled to the armature 308. Although the spring 320 may be variously implemented, in the depicted embodiment it is implemented as a tubular spring that surrounds the armature first end 324.

With the configuration described herein, when the stator windings 104 are energized, the generated magnetic field causes the rotor 106 (and thus the shaft 108) to rotate about the first rotational axis 114-1. As noted above, a load 122, such as the depicted propeller, may be coupled to the shaft 108 to receive the torque supplied therefrom. More specifically, when the stator windings 104 are energized with alternating current (AC) voltages, a Lorentz force is generated between the stator windings 104 and the magnets 214, which in turn imparts a torque to the rotor 106 (and thus the shaft 108) that causes it to rotate about the first rotational axis 114-1 (e.g., spin axis).

Moreover, when the actuation coil 312 in the limited angle torque motor 110 is energized, it will cause the armature 308, and thus the rotor 106 and shaft 108, to rotate about the second rotational axes 114-2. More specifically, when the actuation coil 408 is energized with a DC voltage, the actuation coil 312 generates a magnetic flux generated that adds to the magnetic flux of the permanent magnets on one side of the air gap and subtracts from the flux of permanent magnets on the other side. This generates a torque on the armature 308, causing it to rotate about the second rotational axis 114-2. The magnitude and direction of the torque depends on the magnitude and direction of the input current supplied to the actuation coil 312.

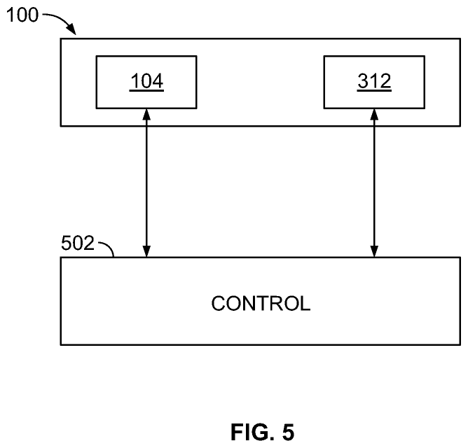

The stator windings 104 and actuation coil 312 are selectively energized via, for example, a controller 502, such as the one depicted in FIG. 5. The controller 502 is coupled to the stator windings 104 and to the actuation coil 312. The controller 502 is configured to control the current magnitude and direction supplied to each of the stator windings 104, to thereby control the direction and rotational speed of the rotor 106 about the first rotational axis 114-1, and is further configured to control the current magnitude and direction supplied to the actuation coil 312, to thereby control the direction and rotational speed of the armature 308 (and thus the rotor 106) about the second rotational axis 114-2. The controller 502 may be configured to implement any one of numerous closed-loop or open-loop control schemes. In a preferred embodiment, the controller implements closed-loop current control for the limited angle torque motor 110.

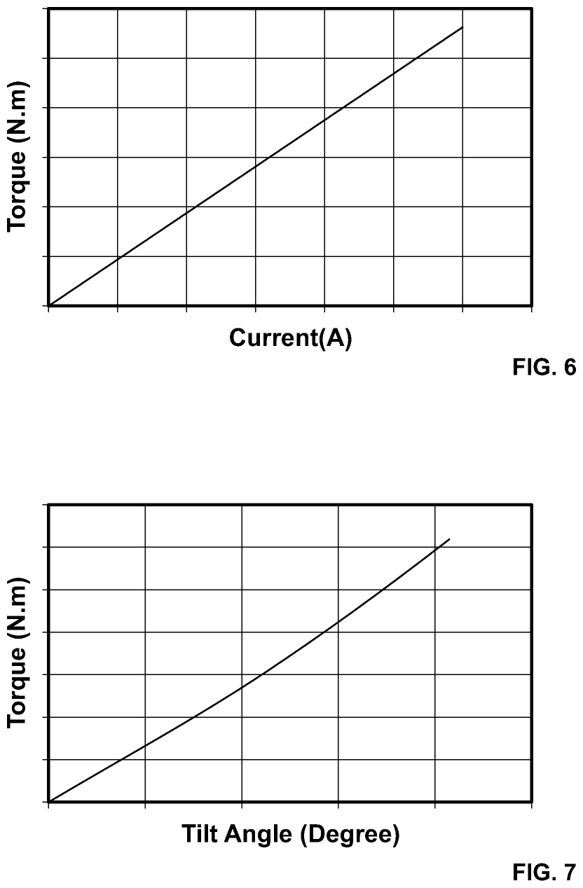

The two degree-of-freedom motor 100 disclosed herein provides several advantages over presently known multi-degree-of-freedom motors. For example, it generates relatively higher torque about the first rotational axis 114-1, at lower temperatures and a higher speed range. In addition, the rotation about the second rotational axis 114-2 is provided at a relatively higher precision and linearity with closed loop current control of current to the limited angle torque motor 110. This can be seen in FIGS. 6 and 7, which graphically depict that the torque about the second rotational axis 114-2 increases linearly with current and tilt angle.

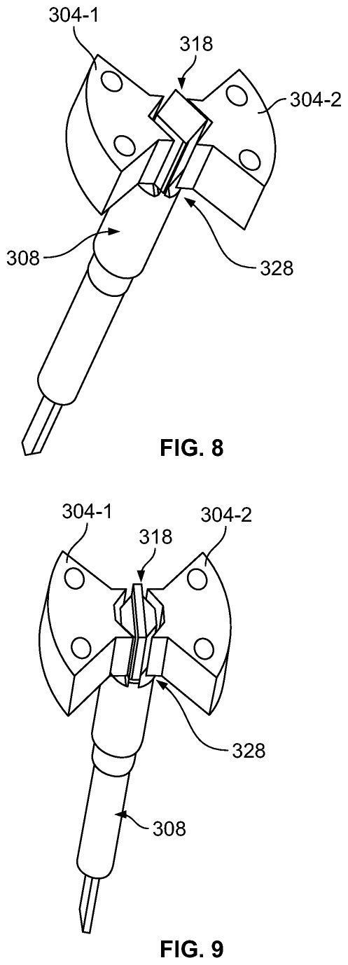

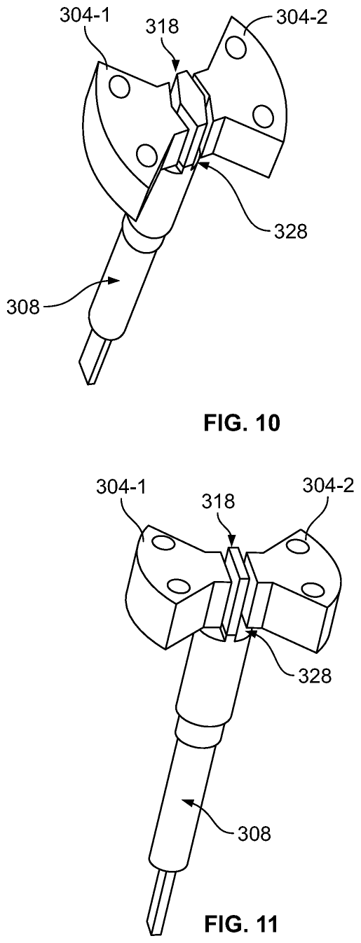

The torque generated about the second rotational axis 114-2 by the limited angle torque motor 110 can be even further improved by varying the shape of the first portion 328 of the armature 308, and by varying the shapes of those portions of the pole pieces 304 and the permanent magnets 306 that define the armature opening 318, such that the first portion 328 of the armature 308 and the armature opening 318 each have a polygonal cross-sectional shape. Some example polygonal cross-sectional shapes for the first portion 328 of the armature 308 and the armature opening 318 are depicted in FIGS. 8-10. Each of these can be compared to FIG. 11, depicts conventional cross-sectional shapes for the first portion 328 of the armature 308 and the armature opening 318. It is noted that for clarity the permanent magnets 306 are not depicted.

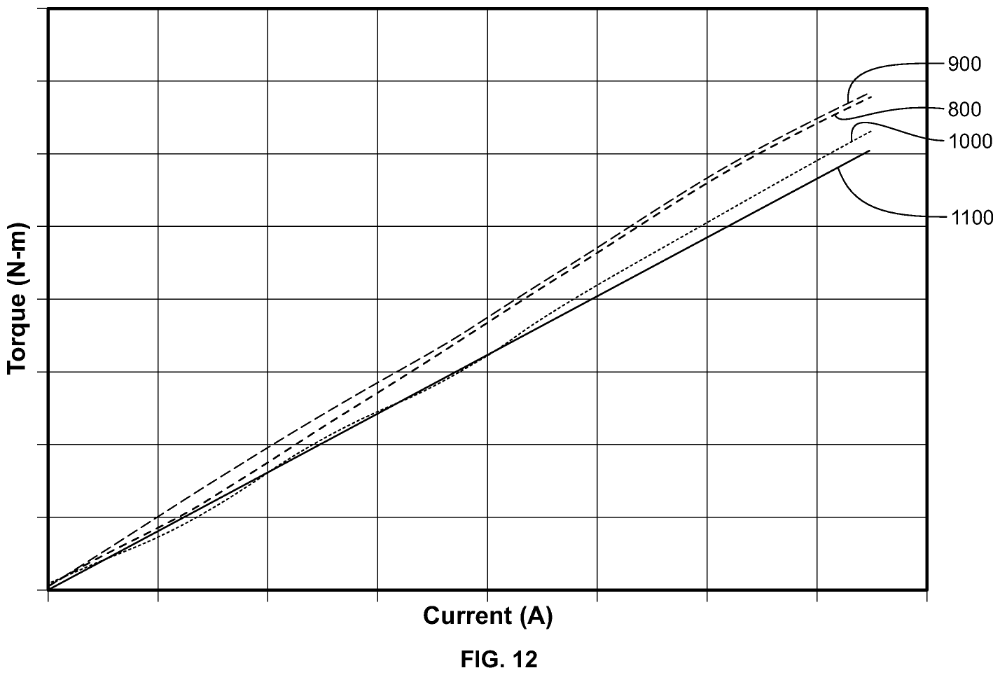

For completeness, the torque vs. current characteristics for the limited angle torque motor 110 implemented with each of the polygonal cross-sectional shapes and the conventional cross-sectional shapes are graphically depicted in FIG. 12. The characteristics labeled 800, 900, and 1000 correspond to the polygonal cross-sectional shapes depicted in FIGS. 8, 9, and 10, respectively, and the characteristic labeled 1100 corresponds to the conventional cross-sectional shape depicted in FIG. 11.

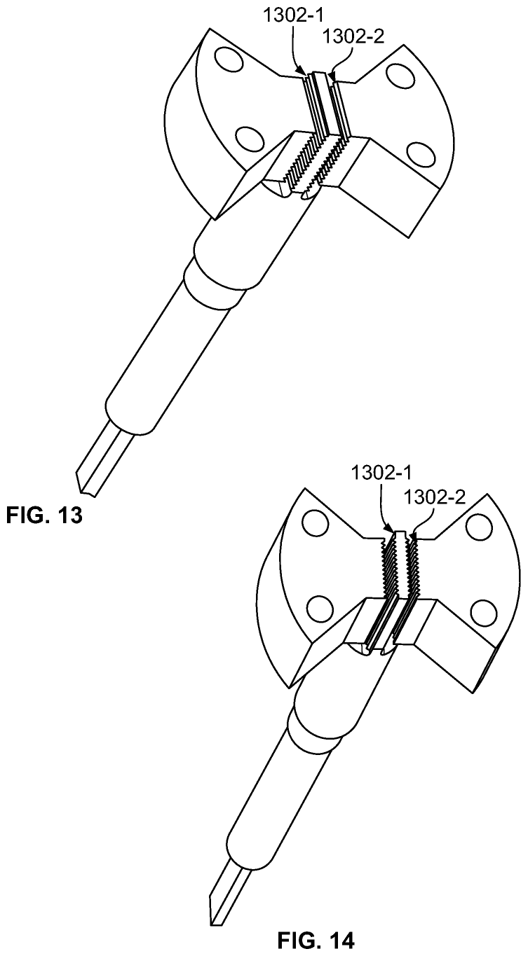

In addition to (or instead of) varying the cross-sectional shapes of the first portion 328 of the armature 308 and the armature opening 318, a portion of the armature pole pieces 304 and the first portion 328 of the armature 308 can be manufactured to have a plurality of grooves formed therein. As FIGS. 13 and 14 depict, these grooves 1302-1, 1302-2 can define either a horizontal sawtooth topology (FIG. 13) or a vertical sawtooth topology (FIG. 14).

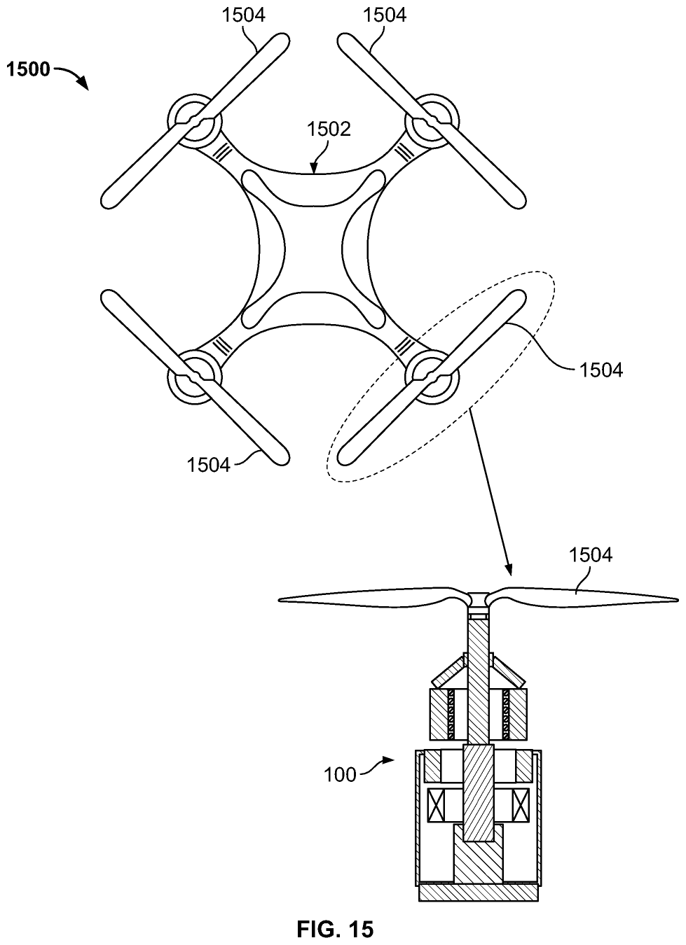

The two degree-of-freedom motor 100 depicted in FIG. 1 and described herein may be used in an unmanned aerial vehicle (UAV), such as the UAV 1500 depicted in FIG. 15. The UAV 1500 depicted therein includes an airframe 1502, a plurality of propellers 1504, and a plurality of two degree-of-freedom motors 100 (only one shown). Each of propellers 1504 is mounted on, and is rotatable relative to, the airframe 1502. Each two degree-of-freedom motor 100 is also mounted on the airframe 1502, and each is coupled to a different one of the propellers 1504. The two degree-of-freedom motors 100 may be controlled via the control 502 of FIG. 5, which may be disposed on or separate from the airframe 1502. If disposed separate from the airframe 1502, the control 502 is configured to in wirelessly communicate with sources of power that supply the currents to the stator windings 104 and the actuation coils 312. If the control 502 is disposed on the airframe 1502, a separate user interface device 1506 may be used to supply commands to the control 502, which in turn controls the currents to the stator windings 104 and the actuation coils 312.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A two degree-of-freedom motor, comprising:
a stator having a main body and a plurality of stator poles extending radially outwardly from the main body;
a plurality of stator windings wound around the stator poles and operable, upon being energized, to generate a magnetic field;
a rotor spaced apart from the stator, the rotor comprising a plurality of magnets and configured to rotate about a first rotational axis;
a shaft coupled to the rotor and rotatable therewith about the first rotational axis, the shaft extending through the stator and having a shaft first end and a shaft second end;
a limited angle torque motor coupled to the shaft first end, the limited angle torque motor operable, upon being energized, to supply a torque to the shaft that causes the shaft, the rotor, and the stator to rotate about a second rotational axis, the second rotational axis perpendicular to the first rotational axis; and
a fixedly mounted spring coupled to the limited angle torque motor.

2. The motor of claim 1, wherein:
the rotor at least partially surrounds the stator; and
the plurality of magnets extend radially inwardly toward the stator poles.

3. The motor of claim 1, wherein:
the stator at least partially surrounds the rotor; and
the plurality of magnets extend radially outwardly toward the stator poles.

4. The motor of claim 1, wherein the limited angle torque motor comprises:
a housing having an inner surface that defines a housing cavity;
a plurality of pole pieces coupled to the housing inner surface and extending into the housing cavity;
a plurality of permanent magnets coupled to the housing inner surface and extending into the housing cavity, each permanent magnet disposed between two of the pole pieces, the pole pieces and permanent magnets together defining an armature opening;
an actuation coil disposed adjacent to the plurality of poles and to the plurality of permanent magnets; and
an armature having an armature first end and an armature second end, the armature first end disposed within the housing cavity and coupled to the fixedly mounted spring the armature second end extending from the housing cavity and coupled to the shaft, a first portion of the armature extending into the armature opening and at least partially surrounded by the pole pieces and the magnets, and a second portion of the armature surrounded by the actuation coil.

5. The motor of claim 4, wherein the armature opening and the first portion of the armature each have a polygonal cross-sectional shape.

6. The motor of claim 4, wherein a portion of the armature poles and the first portion of the armature each have a plurality of grooves formed therein.

7. The motor of claim 4, wherein the fixedly mounted spring comprises a tubular spring.

8. The motor of claim 7, wherein the tubular spring is fixedly mounted within the housing cavity and surrounds the armature first end.

9. A two degree-of-freedom motor system, comprising:
a stator having a main body and a plurality of stator poles extending radially outwardly from the main body;
a plurality of stator windings wound around the stator poles and operable, upon being energized, to generate a magnetic field;
a rotor spaced apart from the stator, the rotor comprising a plurality of magnets and configured to rotate about a first rotational axis;
a shaft coupled to the rotor and rotatable therewith about the first rotational axis, the shaft extending through the stator and having a shaft first end and a shaft second end; and
a limited angle torque motor coupled to the shaft first end, the limited angle torque motor operable, upon being energized, to supply a torque to the shaft that causes the shaft, the rotor, and the stator to rotate about a second rotational axis, the second rotational axis perpendicular to the first rotational axis;
a fixedly mounted spring coupled to the limited angle torque motor; and
a control in operable communication with the stator windings and the limited angle torque motor, the control configured to controllably supply current to the stator windings and the limited angle torque motor.

10. The system of claim 9, wherein:
the rotor at least partially surrounds the stator; and
the plurality of magnets extend radially inwardly toward the stator poles.

11. The motor of claim 9, wherein:
the stator at least partially surrounds the rotor; and
the plurality of magnets extend radially outwardly toward the stator poles.

12. The motor of claim 9, wherein the limited angle torque motor comprises:
a housing having an inner surface that defines a housing cavity;
a plurality of pole pieces coupled to the housing inner surface and extending into the housing cavity;
a plurality of permanent magnets coupled to the housing inner surface and extending into the housing cavity, each permanent magnet disposed between two of the pole pieces, the pole pieces and permanent magnets together defining an armature opening;
an actuation coil disposed adjacent to the plurality of poles and to the plurality of permanent magnets; and
an armature having an armature first end and an armature second end, the armature first end disposed within the housing cavity and coupled to the fixedly mounted spring the armature second end extending from the housing cavity and coupled to the shaft, a first portion of the armature extending into the armature opening and at least partially surrounded by the pole pieces and the magnets, and a second portion of the armature surrounded by the actuation coil.

13. The motor of claim 12, wherein the armature opening and the first portion of the armature each have a polygonal cross-sectional shape.

14. The motor of claim 12, wherein a portion of the armature poles and the first portion of the armature each have a plurality of grooves formed therein.

15. The motor of claim 12, wherein the fixedly mounted spring comprises a tubular spring.

16. The motor of claim 15, wherein the tubular spring is fixedly mounted within the housing cavity and surrounds the armature first end.

17. An unmanned aerial vehicle (UAV), comprising:
an airframe;
a plurality of propellers rotatable relative to the airframe; and
a plurality of two degree-of-freedom motors mounted on the airframe, each two degree-of-freedom motor coupled to a different one of the propellers, each of the two degree-of-freedom motors comprising:
a stator having a main body and a plurality of stator poles extending radially outwardly from the main body;
a plurality of stator windings wound around the stator poles and operable, upon being energized, to generate a magnetic field;
a rotor spaced apart from the stator, the rotor comprising a plurality of magnets and configured to rotate about a first rotational axis;
a shaft coupled to the rotor and rotatable therewith about the first rotational axis, the shaft extending through the stator and having a shaft first end and a shaft second end, the shaft second end coupled to one of the propellers;
a limited angle torque motor coupled to the shaft first end, the limited angle torque motor operable, upon being energized, to supply a torque to the shaft that causes the shaft, the rotor, and the stator to rotate about a second rotational axis, the second rotational axis perpendicular to the first rotational axis; and
a fixedly mounted spring coupled to the limited angle torque motor.

18. The UAV of claim 17, wherein each limited angle torque motor comprises:
a housing having an inner surface that defines a housing cavity;
a plurality of pole pieces coupled to the housing inner surface and extending into the housing cavity;
a plurality of permanent magnets coupled to the housing inner surface and extending into the housing cavity, each permanent magnet disposed between two of the pole pieces;
an actuation coil disposed adjacent to the plurality of poles and to the plurality of permanent magnets; and
an armature having an armature first end and an armature second end, the armature first end disposed within the housing cavity and coupled to the fixedly mounted spring the armature second end extending from the housing cavity and coupled to the shaft, a first portion of the armature at least partially surrounded by the pole pieces and the magnets and a second portion of the armature surrounded by the actuation coil.

19. The UAV of claim 17, wherein:
each fixedly mounted spring comprises a tubular spring; and
each tubular spring is fixedly mounted within the housing cavity and surrounds the armature first end.

20. The UAV of claim 17, further comprising:
a control in operable communication with each of the stator windings and each of the limited angle torque motors, the control configured to controllably supply current to each of the stator windings and each of the limited angle torque motors.
